(19) United States
(12) Patent Application Publication
(10) Pub. No.: US 2025/0308538 A1
(43) Pub. Date: Oct. 2, 2025

(54) AUDIO PROCESSING METHOD, ELECTRONIC DEVICE AND STORAGE MEDIUM

(71) Applicant: AAC Acoustic Technologies (Shanghai) Co., Ltd., Shanghai (CN)

(72) Inventors: Mingxin Hui, Shanghai (CN); Xuejing Sun, L.A., CA (US)

(21) Appl. No.: 18/757,378

(22) Filed: Jun. 27, 2024

Related U.S. Application Data
(63) Continuation of application No. PCT/CN2024/084857, filed on Mar. 29, 2024.

(51) Int. Cl. G10L 19/02; G10L 25/51

(52) U.S. Cl. CPC G10L 19/0204; G10L 25/51

(57) ABSTRACT

Provided are an audio processing method, an electronic device and a storage medium, relating to the field of audio and video technology. The audio processing method includes: classifying audio according to contents of the audio; determining a high-frequency restoration weight and a low-frequency restoration weight based on a classification result; performing amplitude superposition on the audio subjected to bandwidth extension and the audio subjected to low-frequency restoration according to the high-frequency restoration weight and the low-frequency restoration weight; and updating a phase with a frequency higher than a cut-off frequency in a result of the amplitude superposition to a corresponding low-frequency phase with a frequency lower than the cut-off frequency, to obtain a restored audio. Improving the quality of audio is at least facilitated.

### CROSS-REFERENCE TO RELATED APPLICATION

The present application is a continuation of PCT Patent Application No. PCT/CN2024/084857, entitled “AUDIO PROCESSING METHOD, ELECTRONIC DEVICE AND STORAGE MEDIUM,” filed Mar. 29, 2024, which is incorporated by reference herein in its entirety.

### TECHNICAL FIELD

The various embodiments described in this document relate in general to the field of audio and video technology, and more specifically to, an audio processing method, an electronic device and a storage medium.

### BACKGROUND

In the field of digital media, audio and video data are represented and stored in digital form. In order to achieve efficient storage and transmission, audio and video data need to be encoded and compressed, the main purpose of which is to reduce the data volume and improve the transmission efficiency by converting original audio and video data into a compressed code stream through encoding. Correspondingly, before playing the audio, it is necessary to restore the encoded data to the original audio and video signals through decoding.

However, the quality of audio currently obtained from decoding is poor, and the playback effect of the audio is not very satisfactory to users.

### SUMMARY

Embodiments of the present disclosure provide an audio processing method, an electronic device and a storage medium, which at least facilitates improving the quality of audio.

According to some embodiments of the present disclosure, one aspect of the embodiments of the present disclosure provides an audio processing method. The audio processing method includes: classifying audio according to contents of the audio; determining a high-frequency restoration weight and a low-frequency restoration weight based on a classification result; performing amplitude superposition on the audio subjected to bandwidth extension and the audio subjected to low-frequency restoration according to the high-frequency restoration weight and the low-frequency restoration weight; and updating a phase with a frequency higher than a cut-off frequency in a result of the amplitude superposition to a corresponding low-frequency phase with a frequency lower than the cut-off frequency, to obtain a restored audio.

In some embodiments of the present disclosure, in response to the audio being classified as mixed sound, determining the high-frequency restoration weight and the low-frequency restoration weight based on the classification result includes: determining two sets of high-frequency restoration weights and low-frequency restoration weights; performing the amplitude superposition on the audio subjected to bandwidth extension and the audio subjected to low-frequency restoration according to the high-frequency restoration weight and the low-frequency restoration weight includes: splitting the audio to obtain a foreground signal and a background signal; performing amplitude superposition on the foreground signal subjected to bandwidth extension and the foreground signal subjected to low-frequency restoration according to one set of the two sets of high-frequency restoration weights and low-frequency restoration weights, and performing amplitude superposition on the background signal subjected to bandwidth extension and the background signal subjected to low-frequency restoration according to the other set of the two sets of high-frequency restoration weights and low-frequency restoration weights.

In some embodiments of the present disclosure, in the one set of the two sets of high-frequency restoration weights and low-frequency restoration weights, the high-frequency restoration weight takes a value approaching a left boundary of a value range of the high-frequency restoration weight, and the low-frequency restoration weight takes a value approaching a right boundary of a value range of the low-frequency restoration weight; and/or in the other set of the two sets of high-frequency restoration weights and low-frequency restoration weights, the high-frequency restoration weight takes a value approaching a right boundary of a value range of the high-frequency restoration weight, and the low-frequency restoration weight takes a value approaching a left boundary of a value range of the low-frequency restoration weight.

In some embodiments of the present disclosure, in response to the audio being classified as music, the high-frequency restoration weight takes a value approaching a right boundary of a value range of the high-frequency restoration weight, and the low-frequency restoration weight takes a value approaching a left boundary of a value range of the low-frequency restoration weight; in response to the audio being classified as human voice, the high-frequency restoration weight takes a value approaching a left boundary of a value range of the high-frequency restoration weight, and the low-frequency restoration weight takes a value approaching a right boundary of a value range of the low-frequency restoration weight; and in response to the audio being classified as noise, the high-frequency restoration weight takes a value approaching a left boundary of a value range of the high-frequency restoration weight, and the low-frequency restoration weight takes a value approaching a left boundary of a value range of the low-frequency restoration weight.

In some embodiments of the present disclosure, before performing amplitude superposition on the audio subjected to bandwidth extension and the audio subjected to low-frequency restoration according to the high-frequency restoration weight and the low-frequency restoration weight, the audio processing method further includes: performing bandwidth extension on the audio according to a coding mode and a code rate in encoding of the audio and a bandwidth expansion model; and performing low-frequency restoration on the audio according to the coding mode and the code rate in encoding of the audio and a low-frequency restoration model.

In some embodiments of the present disclosure, classifying the audio according to the contents of the audio includes: classifying the audio according to a content of at least one of a history frame and a current frame in the audio.

In some embodiments of the present disclosure, updating the phase with the frequency higher than the cut-off frequency in the result of the amplitude superposition to the corresponding low-frequency phase with the frequency lower than the cut-off frequency includes: determining a phase corresponding to the result of the amplitude superposition according to the following expression:

$$∠Y = \{ \begin{matrix}∠X ( f ) , f < {f}_{c} \\ ∠X ( 2 {f}_{c} - f ) , f > {f}_{c}\end{matrix} ,$$

where <Y denotes the phase corresponding to the result of the amplitude superposition, <X(f) denotes a phase of the audio, and f_{c} denotes the cut-off frequency of the audio.

In some embodiments of the present disclosure, performing the amplitude superposition on the audio subjected to bandwidth extension and the audio subjected to low-frequency restoration according to the high-frequency restoration weight and the low-frequency restoration weight includes: performing the amplitude superposition by the following expression: |Y|=|X|+α|X|_{BWE}+β|X|_{LFR}, where |Y| denotes the result of the amplitude superposition, |X|_{BWE} denotes an amplitude of the audio subjected to bandwidth extension, |X|_{LFR} denotes an amplitude of the audio subjected to low-frequency restoration, α denotes the high-frequency restoration weight, β denotes the low-frequency restoration weight, |X| denotes an amplitude of the audio X, and a, β each have a value range of 0 to 1.

According to some embodiments of the present disclosure, another aspect of the embodiments of the present disclosure provides an electronic device. The electronic device includes at least one processor, and a memory communicatively connected to the at least one processor. The memory stores instructions executable by the at least one processor, and the instructions are configured to cause, when executed by the at least one processor, the at least one processor to perform the audio processing method according to any one of the embodiments of the present disclosure.

According to some embodiments of the present disclosure, yet another aspect of the embodiments of the present disclosure provides a computer readable storage medium storing a computer program. The computer program is configured to perform, when executed by a processor, the audio processing method according to any one of the embodiments of the present disclosure.

### BRIEF DESCRIPTION OF THE DRAWINGS

One or more embodiments are exemplarily described with reference to the corresponding figures in the accompanying drawings, and the exemplary descriptions are not to be construed as limiting the embodiments. Elements having the same reference numeral in the accompanying drawings are represented as similar element. Unless otherwise particularly stated, the figures in the accompanying drawings are not drawn to scale.

FIG. 1 is an audio spectrum before encoding according to the present disclosure.

FIG. 2 is an audio spectrum after encoding according to the present disclosure.

FIG. 3 is another audio spectrum after encoding according to the present disclosure.

FIG. 4 is yet another audio spectrum after encoding according to the present disclosure.

FIG. 5 is a first flowchart of an audio processing method according to embodiments of the present disclosure.

FIG. 6 is a second flowchart of an audio processing method according to embodiments of the present disclosure.

FIG. 7 is a third flow chart of an audio processing method according to embodiments of the present disclosure.

FIG. 8 is a flowchart of a process of separating a foreground signal and a background signal in an audio processing method according to embodiments of the present disclosure.

FIG. 9 is a fourth flow chart of an audio processing method according to embodiments of the present disclosure.

FIG. 10 is a schematic structure diagram of an electronic device according to embodiments of the present disclosure.

### DETAILED DESCRIPTION OF THE EMBODIMENTS

As can be seen from the background section, the existing audio encoding and decoding technology has the problem that the quality of the decoded audio is poor and is desired to be improved.

Upon analysis, the reason for the above problem is at least as follows. When encoding and decoding audio, due to the limitation of storage space or transmission bandwidth, the audio is often encoded in a low code rate, and the existing coding scheme selectively ignores some information in the audio at the low code rate, which results in the auditory sensation of the audio being altered, in particular, with the reduction of coding code rate, more information may be lost, and correspondingly the auditory sensation of the audio may be worse. There are two types of auditory sensation loss after an audio source is encoded at a low code rate.

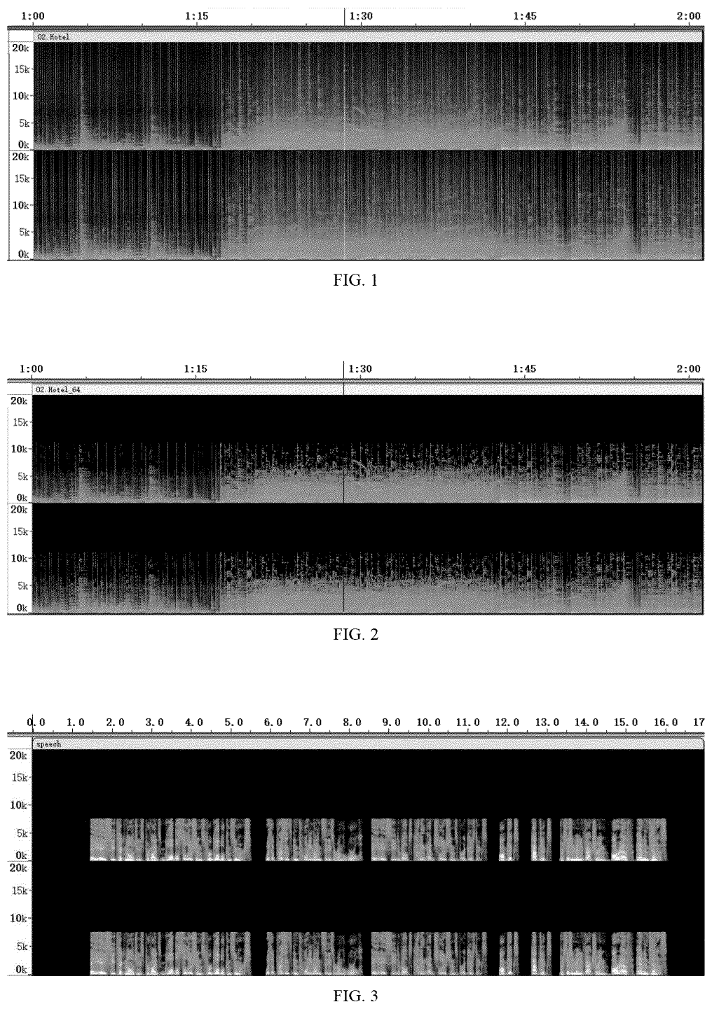

The first type is high-frequency information. Specifically, in low code-rate encoding, in order to reduce the size of the encoded file, high-frequency information is often discarded, which makes the decoded audio have only a low-frequency part and tend to be rough and low in auditory sensation. For example, comparing the audio spectrum before encoding shown in FIG. 1 with the audio spectrum after MP3 encoding at 64 kbps shown in FIG. 2, it can be seen that a high-frequency part of the encoded audio above 10 kHz is completely lost, and a mid-high frequency part of the audio from 6 kHz to 10 kHz is also greatly lost. In FIG. 1 and FIG. 2, the abscissa represents timestamps of audio, and the ordinate represents frequency.

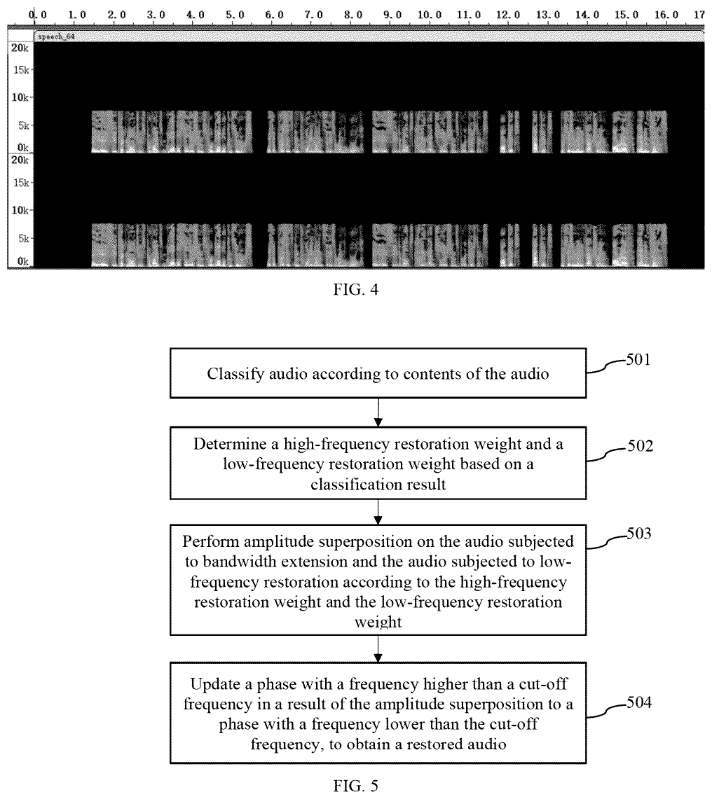

The second type is low-frequency information. In an audio encoding process, an original audio signal needs to be quantized using a quantizer, and when the coding code rate is low, the accuracy of the quantizer is often set very low, which makes the quantized dynamic range difficult to match the actual signal, leading to part of signal frequencies being quantized as 0 or 1. That is, the phenomenon of birdies occurs, resulting in spectral gap or spectral island in the frequency spectrum and then affecting the auditory sensation of the decoded audio. At the same time, in the low code-rate encoding, the auditory masking effect of the human ear is often taken into account. Due to the auditory masking effect, the human ear is less sensitive to certain audio information, and discarding this audio information has a small impact on the auditory sensation. Such discarding also causes the spectral gap or spectral island in the frequency spectrum. However, since the auditory masking effect of each person is not completely the same, the degree of sensitivity to the discarded information of each person is different, and thus for low code-rate audio, the degradation of the auditory sensation due to missing information is still perceptible. For example, comparing the audio spectrum before encoding shown in FIG. 1 with the audio spectrum after MP3 encoding at 64 kbps shown in FIG. 3 and FIG. 4, the audio spectrum after encoding is no longer completely continuous, but has intervals, i.e., the spectral gap or spectral island in the frequency spectrum.

To this end, embodiments of the present disclosure provide an audio processing method, an electronic device, and a storage medium, which flexibly determines a high-frequency restoration weight and a low-frequency restoration weight for audio according to contents of the audio to control the high-frequency restoration and low-frequency restoration effect of the audio, so that the final restoration effect of the audio can be adapted to the contents. In this manner, missing high-frequency information, masking information and spatial information in the low code-rate audio can be better restored, and the auditory sensation of the decoded low code-rate audio can be improved.

In order to make objects, technical solutions and advantages of the embodiments of the present disclosure clearer, the embodiments of the present disclosure will be described in detail below in connection with the accompanying drawings. However, a person of ordinary skill in the art can understand that in the various embodiments of the present disclosure, a number of technical details are proposed to enable the reader to better understand the present disclosure. However, even without these technical details and various variations and modifications based on the following embodiments, the claimed technical solutions of the present disclosure can be achieved.

The following embodiments are divided for the convenience of description, and shall not constitute any limitation on the implementations of the present disclosure. Without conflict, various embodiments may be combined with and referred to each other.

Embodiments of the present disclosure provide an audio processing method, applied to an electronic device such as a mobile phone, a computer or a music player. In some embodiments, a flow of the audio processing method is shown in FIG. 5 and includes the following operations.

At operation 501, audio is classified according to contents of the audio.

At operation 502, a high-frequency restoration weight and a low-frequency restoration weight are determined based on a classification result.

At operation 503, amplitude superposition is performed on the audio subjected to bandwidth extension and the audio subjected to low-frequency restoration according to the high-frequency restoration weight and the low-frequency restoration weight.

At operation 504, a phase with a frequency higher than a cut-off frequency in a result of the amplitude superposition is updated to a phase with a frequency lower than the cut-off frequency, to obtain a restored audio.

In this way, the audio is classified according to the contents of the audio, so that the classification result can be utilized to accurately determine the appropriate high-frequency restoration weight and low-frequency restoration weight, and thus, the amplitude superposition is performed on the audio subjected to bandwidth extension and the audio subjected to low-frequency restoration according to the accurate high-frequency restoration weight and low-frequency restoration weight, whereby the restoration effect of the high-frequency and low-frequency parts of the audio can be more accurately and independently controlled. In addition, the phase with the frequency higher than the cut-off frequency in the audio is updated to the phase with the frequency lower than the cut-off frequency, avoiding excessive restoration of the high-frequency part of the audio. Thus, achieving a better audio restoration effect is facilitated, improving the quality of the audio.

In order to facilitate a better understanding of the embodiments shown in FIG. 5 by those skilled in the art, the description of the embodiments is given below.

For the operation 501, it is to be understood that the audio is composed of different audio frames. Therefore, in some examples, all audio frames included in the audio may be classified, which enables the processing of the audio to be completed at one time and facilitates processing the audio more efficiently. However, this may reduce the accuracy of the classification for a particular frame. Therefore, in other examples, the audio may also be processed frame by frame; or, the audio may be classified and subsequently processed with a plurality of consecutive frames (or a plurality of consecutive frames with substantially unchanged contents) as a whole to improve the processing accuracy of each audio frame, which is conducive to further improving the processing effect of each audio frame, thereby achieving better audio quality.

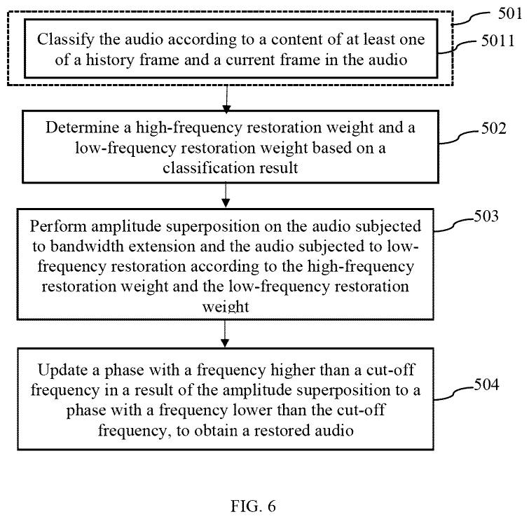

Moreover, it is also to be understood that in the case where the audio is composed of different audio frames, the audio frames contained in the audio are usually related to each other in content, that is, an audio frame at the front may provide a classifying reference for an audio frame at the back. Based on this, in some embodiments, as shown in FIG. 6, classifying the audio according to the contents of the audio may be implemented by the following operations.

At operation 5011, the audio is classified according to a content of at least one of a history frame and a current frame in the audio.

That is, the historical frame, such as a previous frame or multiple frames prior to the current frame, may be referred to in classifying. In this way, the historical frame can be used as a reference to predict the classification result of the audio frame in advance, so that the subsequent processing of the audio frame can be initiated more efficiently, which is conducive to the application in audio streaming and other scenarios with high real-time requirements for audio processing and can reduce the time delay of the audio processing and improve the user experience. Moreover, in the case where both the current frame and the historical frame are used for classification, the accuracy of the classification can be improved due to the fact that the classification refers to more information, thus ensuring the accuracy of the subsequent audio processing, which is conducive to improving the restoration effect of the audio and thus improving the quality of the audio.

It is to be noted that this embodiment does not limit the method of classification. The method of classification may be just content classification, audio source switching identification, or a combination thereof, etc., which will not go into detail here.

It is also to be noted that the embodiments of the present disclosure do not limit the various scenarios and the specific number of categories of audio. It is to be understood that it may be any kind of classification that is conducive to distinguishing weights of the high-frequency contents and the low-frequency contents in the audio, so that subsequent operations are enabled to determine the high-frequency restoration weight and the low-frequency restoration weight based on the weights of the high-frequency contents and the low-frequency contents reflected by the categories.

In some embodiments, the categories of the audio may include at least one of music, human voice, noise, and mixed sound. For example, based on the current audio content and the previous audio content, the audio may be classified into four categories: pure music, pure human voice, noise and mixed sound.

It is to be understood that for different audio contents, the audio has different high-frequency characteristics and low-frequency characteristics, corresponding lost information would be different, and thus for different audio contents, there should be different emphases on high-frequency restoration and low-frequency restoration. For example, there are usually more original high-frequency components in music, therefore, after the low code-rate encoding, the original high-frequency components of the music may be missing, which seriously affects the auditory sensation, that is, the restoration focuses more on using the high-frequency extension to add more high-frequency components, which is more conducive to improving the quality of auditory sensation. The energy and effective information of the human voice are mainly concentrated in the mid-low frequency, therefore, the main loss after encoding is the information loss caused by the Birdies phenomenon due to quantization, that is, the restoration focuses more on suppressing the Birdies phenomenon through low-frequency restoration, which is more conducive to improving the quality of the auditory sensation. In addition, there is usually no practical restoration significance to noise, and therefore, neither high-frequency restoration nor low-frequency restoration is necessary.

Based on this, for the operation 502, in some embodiments, in response to the audio being classified as music, the high-frequency restoration weight may take a value approaching a right boundary of a value range of the high-frequency restoration weight, and the low-frequency restoration weight may take a value approaching a left boundary of a value range of the low-frequency restoration weight. In this way, taking into full account that there is usually a large proportion of high-frequency contents in the music and produced losses mainly comes from the high-frequency contents, the best restoration effect can be achieved by maximizing the high-frequency restoration, and the high-frequency contents can be highlighted by minimizing the low-frequency restoration, thereby enabling a better high-frequency playback effect of the music and thus presenting a better experience of auditory sensation. It is to be noted that the left boundary of the value range herein refers to the lower limiting value of the value range, and the right boundary of the value range herein refers to the upper limiting value of the value range.

In some embodiments, in response to the audio being classified as human voice, the high-frequency restoration weight may take a value approaching a left boundary of the value range of the high-frequency restoration weight, and the low-frequency restoration weight may take a value approaching a right boundary of the value range of the low-frequency restoration weight. In this way, taking into full account the characteristic of the human voice with a principally mid-low frequency, the best restoration effect can be achieved by maximum restoration of lost low-frequency parts, and interference of high-frequency contents with low-frequency contents can be avoided by minimizing the high-frequency restoration, thereby enabling a better high-frequency playback effect of the human voice and thus presenting a better experience of auditory sensation.

In some embodiments, in response to the audio being classified as noise, the high-frequency restoration weight may take a value approaching the left boundary of the value range of the high-frequency restoration weight, and the low-frequency restoration weight may take a value approaching the right boundary of the value range of the low-frequency restoration weight. In this way, it is possible to make the restoration of noise have the same processing flow as the restoration of music and human voice, avoiding meaningless restoration operations and reducing the waste of resources, and avoid erroneous audio adjustments, such as adjustment of white noise for sleep aids.

Of course, in some cases, when the category of the audio is noise, it is also possible not to perform any restoration, which is not repeated here.

Similarly, for mixed sound, i.e., audio obtained by mixing different sounds in various ways, such as mixing music with human voice, mixing human voice with noise, or the like. The background signal usually includes those continuous and stable sounds, such as ambient sounds or smaller musical accompaniments, and the foreground signal originates from prominent direct sound sources, including speaking voice, singing voice, loud musical instrument sound, and so on. Therefore, when bandwidth expansion is performed on the foreground signal, it is likely to lead to cracking voice and increased auditory roughness, which affects the auditory sensation. Therefore, in some examples, the audio may be regarded as a superposition of different contents when the category of the audio is mixed sound, and specifically, in the mixed sound, the foreground signal is dominated by transient signals and the background signal is dominated by steady signals. The transient signals are not suitable for high-frequency expansion restoration, otherwise noise is easily introduced, while the Birdies phenomenon in the steady signals has less impact on the auditory sensation, so the low-frequency restoration does little to enhance the user's auditory sensation. In other words, the foreground signal and background signal in the mixed sound have different characteristics, with different emphases on high-frequency expansion and low-frequency restoration, so it is not appropriate to adopt the same restoration processing. Therefore, in order to better meet restoration needs of different contents in the mixed sound, the mixed sound may be split, and then the split foreground signal and background signal may be processed separately to avoid the mutual influence in the restorations of the foreground signal and background signal.

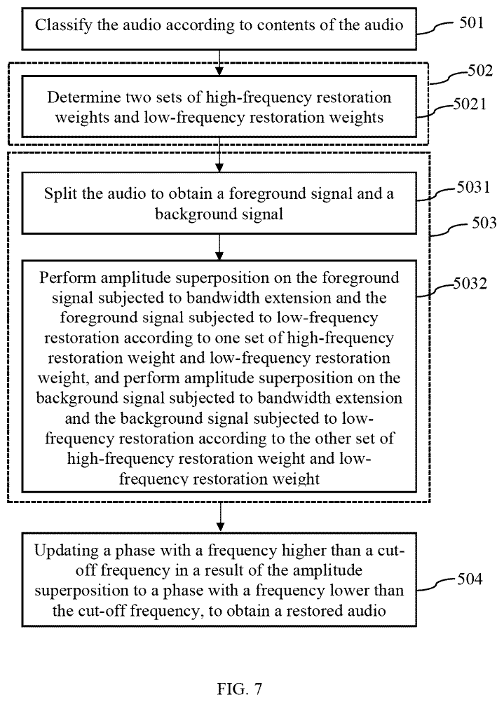

Based on this, in some embodiments, as shown in FIG. 7, in response to the audio being classified as the mixed sound, determining the high-frequency restoration weight and the low-frequency restoration weight based on the classification result including may be implemented by the following operations.

At operation 5021, two sets of high-frequency restoration weights and low-frequency restoration weights are determined.

Accordingly, performing the amplitude superposition on the audio subjected to bandwidth extension and the audio subjected to low-frequency restoration according to the high-frequency restoration weight and the low-frequency restoration weight may be implemented by the following operations.

At operation 5031, the audio is split to obtain a foreground signal and a background signal.

At operation 5032, amplitude superposition are performed on the foreground signal subjected to bandwidth extension and the foreground signal subjected to low-frequency restoration according to one set of the two sets of high-frequency restoration weights and low-frequency restoration weights, and amplitude superposition are performed on the background signal subjected to bandwidth extension and the background signal subjected to low-frequency restoration according to the other set of the two sets of high-frequency restoration weights and low-frequency restoration weights.

In this way, by splitting the audio to obtain the primarily mid-low frequency foreground signal and the primarily high frequency background signal, restoration can be performed for corresponding loss characteristics, avoiding the mutual interference between the mid-low frequency content restoration and the high frequency content restoration, which is conducive to improving the restoration effect of the audio and further improving the quality of the audio.

It should be noted that the embodiments of the present disclosure do not limit the splitting of the audio. In some embodiments, the foreground signal may be divided into two parts: one part is a short-lived transient signal in the audio, and the other part is a tonal signal caused by voice or a musical instrument. In other words, the foreground signal can be removed from the signal by attenuating the above two parts separately in the original audio, to obtain the background signal, thus realizing the separation of the background signal from the foreground signal.

In some embodiments, as shown in FIG. 8, frequency spectrum combination is performed on an audio signal X(k) after transient attenuation and tonal attenuation to obtain the background signal. Then, the foreground signal may be obtained by removing the background signal from the audio signal. In this case, assuming that a signal gain from the transient attenuation is Gₜᵣₐₙ and a signal gain from the tonal attenuation is Gₜₒₙₐ, a signal gain of the background signal relative to the audio signal is G=min(Gₜᵣₐₙ, Gₜₒₙₐ). That is, a signal spectrum of the background signal is: |B(k)|=|X(k)|*G. Correspondingly, a signal spectrum of the foreground signal is |F(k)|=|X(k)|−|B(k)|.

With respect to the two sets of high-frequency restoration weights and low-frequency restoration weights in the above embodiments, according to the characteristic that different contents in the previously-described mixed sound have different emphases on restoration needs, corresponding high-frequency restoration weights and low-frequency restoration weights may be flexibly set. That is, in some embodiments, in the amplitude superposition of the foreground signal subjected to bandwidth extension and the foreground signal subjected to low-frequency restoration, the used high-frequency restoration weight takes a value approaching the left boundary of the value range the high-frequency restoration weight, and the used low-frequency restoration weight takes a value approaching the right boundary of the value range of the low-frequency restoration weight, to fit the mid-low frequency characteristics of the foreground signal, which is conducive to achieving a better restoration effect. In some embodiments, in the amplitude superposition of the background signal subjected to bandwidth extension and the background signal subjected to low-frequency restoration, the used high-frequency restoration weight takes a value approaching the right boundary of the value range the high-frequency restoration weight, and the used low-frequency restoration weight takes a value approaching the left boundary of the value range of the low-frequency restoration weight, to fit the high frequency characteristics of the background signal, which is conducive to achieving a better restoration effect.

For operation 503, the embodiments of the present disclosure do not limit the manners of bandwidth extension (BWE) and low-frequency restoration (LFR) of the audio, which may be any scheme achieving the corresponding effects.

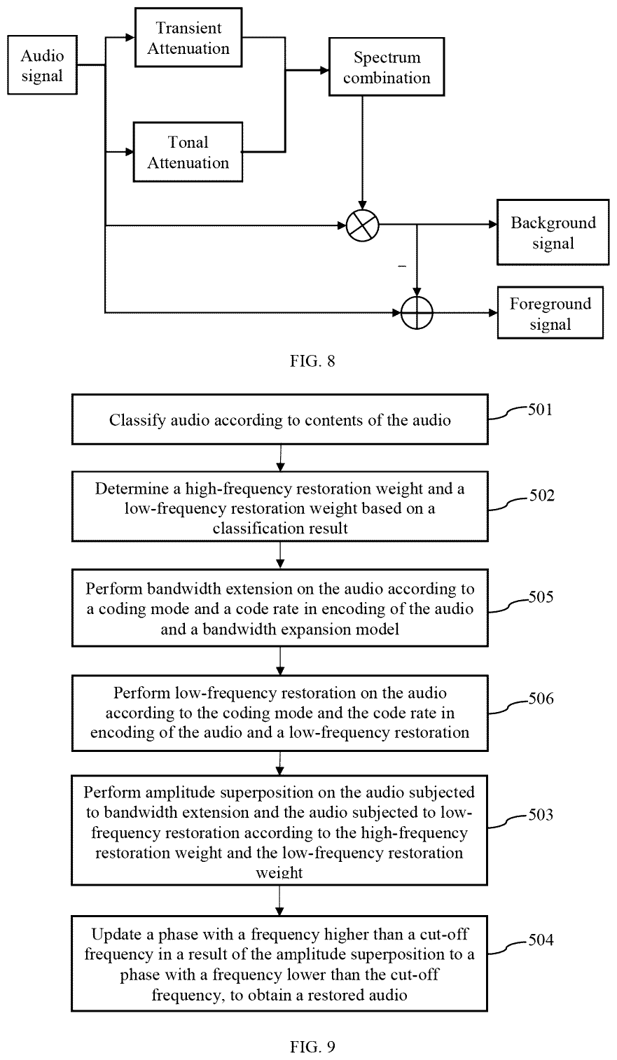

In some embodiments, as shown in FIG. 9, before performing the amplitude superposition on the audio subjected to bandwidth extension and the audio subjected to low-frequency restoration according to the high-frequency restoration weight and the low-frequency restoration weight, the audio processing method further includes the following operations.

At operation 505, bandwidth extension is performed on the audio according to a coding mode and a code rate in encoding of the audio and a bandwidth expansion model.

At operation 506, low-frequency restoration is performed on the audio according to the coding mode and the code rate in encoding of the audio and a low-frequency restoration model.

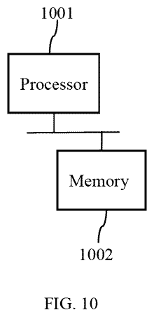

That is, two models (i.e., the bandwidth expansion model and the low-frequency restoration spread model) may be used to implement the relevant restorations respectively, as shown in FIG. 10, where X is the audio, and the apriori information is the coding mode and the code rate in encoding of the audio. The coding mode includes MP3, advanced audio coding (AAC), Opus, etc., and the code rate includes 64 kbps, 96 kbps, 128 kbps, etc.

It should be noted that the reason why the model uses the coding mode and code rate as the apriori information is mainly because different coding modes and code rates generally have different cut-off frequencies and low-frequency loss degrees. Therefore, by providing the coding mode and code rate as the apriori information, more accurate parameters or configurations can be selected for the model to perform audio restoration, which is conducive to more accurate restoration and further improvement of the restoration effect of the audio, thereby improving the audio quality.

In order to facilitate a better understanding of the scheme of amplitude superposition by those skilled in the art, operations 503 and 504 are illustrated below by way of example. It should be noted that the following description is only an exemplary illustration and does not imply that the operations 503 and 504 can only be implemented in the following manner.

In some embodiments, performing amplitude superposition on the audio subjected to bandwidth extension and the audio subjected to low-frequency restoration according to the high-frequency restoration weight and the low-frequency restoration weight is implemented by the following expression:

$$\vert Y \vert = \vert X \vert + α {\vert X \vert}_{BWE} + β {\vert X \vert}_{LFR} ,$$

where |Y|denotes a result of the amplitude superposition, |X|_{BWE} denotes an amplitude of the audio subjected to bandwidth expansion, |X|_{LFR} denotes an amplitude of the audio subjected to low-frequency restoration, α denotes the high-frequency restoration weight, β denotes the low-frequency restoration weight, and |X| denotes an amplitude of the audio X.

In some embodiments, the value ranges of a, β may both be set to (0, 1). Of course, in other embodiments, the specific value ranges of α, β may also be set according to the demand, which will not be repeated here.

In this way, the amplitude of the audio is also introduced into the superimposed amplitude, and the value ranges of α, β are both set to (0, 1), so as to achieve the moderate restoration of the audio, avoiding that the restored signal is over-adjusted or has an insufficient amplitude.

For the above given range values of α, β, in response to the category of the audio being music, α may take a value approaching 1, and β may take a value approaching 0. Exemplarily, in response to the audio being classified as music, α may be 0.5 to 1, for example, 0.6, 0.7, 0.8 and 0.9; and β may be 0 to 0.5, for example, 0.1, 0.2, 0.3, 0.4. In response to the audio being classified as human voice, α may take a value approaching 0, and β may take a value approaching 1. Exemplarily, in response to the audio being classified as human voice, α may be 0 to 0.5, for example, 0.1, 0.2, 0.3, 0.4; and β may be 0.5 to 1, for example, 0.6, 0.7, 0.8 and 0.9. In response to the audio being classified as noise, α may take a value approaching 0, and β may take a value approaching 0. Exemplarily, in response to the audio being classified as noise, α may be 0 to 0.5, for example, 0.1, 0.2, 0.3, 0.4; and β may be 0 to 0.5, for example, 0.1, 0.2, 0.3, 0.4.

In some embodiments, modifying a phase with a frequency higher than the cut-off frequency in the result of the amplitude superposition to a low-frequency phase with a frequency lower than the cut-off frequency is implemented according to the following expression:

$$∠Y = \{ \begin{matrix}∠X ( f ) , f < {f}_{c} \\ ∠X ( 2 {f}_{c} - f ) , f > {f}_{c}\end{matrix} ,$$

where <Y denotes the phase corresponding to the result of the amplitude superposition, <X(f) denotes a phase of the audio, and f_{c} is the cut-off frequency of the audio.

Thereby, the signal acquired based on the amplitude obtained from the above superposition and the determined phase may be subjected to Fourier inversion to obtain a time-domain signal y, i.e., a processed high-quality audio.

The above division of operations of the method is only for the purpose of clear description, where when the method is implemented, some operations may combined into one operation, or a certain operation may be split into multiple operations, as long as the same logical relationship is included, which are all within the scope of protection of the present disclosure. The algorithm or process that is added with insignificant modifications or introduced with insignificant design without changing the core design of the algorithm or process is also within the scope of protection of the present disclosure.

Another aspect of embodiments of the present disclosure provides an electronic device. As shown in FIG. 10, the electronic device includes at least one processor 1001 and a memory 1002 communicatively coupled to the at least one processor 1001. The memory 1002 stores instructions that are executable by the at least one processor 1001, and the instructions cause, when executed by the at least one processor 1001, the at least one processor 1001 to perform the audio processing method described in any of the above method embodiments.

The memory 1002 is connected to the at least one processor 1001 by means of a bus which may include any number of interconnected buses and bridges. The bus connects various circuits of the at least one processor 1001 and the memory 1002 together. The bus may also connect together various other circuits such as peripherals, voltage regulators, and power management circuits, all of which are well known in the art and, therefore, are not further described herein. A bus interface provides an interface between the bus and a transceiver. The transceiver may be a single element, or a plurality of elements such as a plurality of receivers and transmitters, providing units for communicating with a variety of other devices on a transmission medium. Data processed by the processor 1001 is transmitted over a wireless medium via an antenna, and further, the antenna also receives data and transmits the data to the processor 1001.

The processor 1001 is responsible for managing the bus and usual processing, and may also provide various functions including timing, peripheral interfacing, voltage regulation, power management, and other control functions. The memory 1002 may be configured to store data used by the processor 1001 in performing operations.

Yet another aspect of embodiments of the present disclosure provides a computer readable storage medium storing a computer program. The computer program is configured to implement, when executed by the processor, the above method embodiments.

That is, a person skilled in the art may understand that all or part of the steps in the method for implementing the above embodiments may be accomplished by a program to instruct a relevant hardware. The program is stored in a storage medium and includes a number of instructions to make a device (which may be a microcontroller, chip, etc.) or processor (processor) perform all or part of the steps of the method described in the various embodiments of the present disclosure. The aforementioned storage medium may include a medium that can store program codes, such as an USB flash drive, a removable hard disk, a read-only memory (ROM), a random access memory (RAM), a magnetic disc, or a compact disc.

The person of ordinary skill in the art may understand that the above embodiments are specific embodiments for implementing the present disclosure, and in practical application, various changes in form and details may be made without deviating from the spirit and scope of the present disclosure.

What is claimed is:

1. An audio processing method, comprising:
classifying audio according to contents of the audio;
determining a high-frequency restoration weight and a low-frequency restoration weight based on a classification result;
performing amplitude superposition on the audio subjected to bandwidth extension and the audio subjected to low-frequency restoration according to the high-frequency restoration weight and the low-frequency restoration weight; and
updating a phase with a frequency higher than a cut-off frequency in a result of the amplitude superposition to a phase with a frequency lower than the cut-off frequency, to obtain a restored audio.

2. The audio processing method according to claim 1, wherein in response to the audio being classified as mixed sound, determining the high-frequency restoration weight and the low-frequency restoration weight based on the classification result includes:
determining two sets of high-frequency restoration weights and low-frequency restoration weights;
wherein performing the amplitude superposition on the audio subjected to bandwidth extension and the audio subjected to low-frequency restoration according to the high-frequency restoration weight and the low-frequency restoration weight includes:
splitting the audio to obtain a foreground signal and a background signal; and
performing first sub-amplitude superposition on the foreground signal subjected to bandwidth extension and the foreground signal subjected to low-frequency restoration according to one set of the two sets of high-frequency restoration weights and low-frequency restoration weights, and performing second sub-amplitude superposition on the background signal subjected to bandwidth extension and the background signal subjected to low-frequency restoration according to the other set of the two sets of high-frequency restoration weights and low-frequency restoration weights.

3. The audio processing method according to claim 2, wherein:
in the one set of the two sets of high-frequency restoration weights and low-frequency restoration weights, the high-frequency restoration weight takes a value approaching a left boundary of a value range of the high-frequency restoration weight, and the low-frequency restoration weight takes a value approaching a right boundary of a value range of the low-frequency restoration weight; and
in the other set of the two sets of high-frequency restoration weights and low-frequency restoration weights, the high-frequency restoration weight takes a value approaching a right boundary of a value range of the high-frequency restoration weight, and the low-frequency restoration weight takes a value approaching a left boundary of a value range of the low-frequency restoration weight.

4. The audio processing method according to claim 2, wherein:
in the one set of the two sets of high-frequency restoration weights and low-frequency restoration weights, the high-frequency restoration weight takes a value approaching a left boundary of a value range of the high-frequency restoration weight, and the low-frequency restoration weight takes a value approaching a right boundary of a value range of the low-frequency restoration weight; or
in the other set of the two sets of high-frequency restoration weights and low-frequency restoration weights, the high-frequency restoration weight takes a value approaching a right boundary of a value range of the high-frequency restoration weight, and the low-frequency restoration weight takes a value approaching a left boundary of a value range of the low-frequency restoration weight.

5. The audio processing method according to claim 1, wherein:
in response to the audio being classified as music, the high-frequency restoration weight takes a value approaching a right boundary of a value range of the high-frequency restoration weight, and the low-frequency restoration weight takes a value approaching a left boundary of a value range of the low-frequency restoration weight;
in response to the audio being classified as human voice, the high-frequency restoration weight takes a value approaching a left boundary of a value range of the high-frequency restoration weight, and the low-frequency restoration weight takes a value approaching a right boundary of a value range of the low-frequency restoration weight; and
in response to the audio being classified as noise, the high-frequency restoration weight takes a value approaching a left boundary of a value range of the high-frequency restoration weight, and the low-frequency restoration weight takes a value approaching a left boundary of a value range of the low-frequency restoration weight.

6. The audio processing method according to claim 1, wherein before performing amplitude superposition on the audio subjected to bandwidth extension and the audio subjected to low-frequency restoration according to the high-frequency restoration weight and the low-frequency restoration weight, the audio processing method further comprises:
performing bandwidth extension on the audio according to a coding mode and a code rate in encoding of the audio and a bandwidth expansion model; and
performing low-frequency restoration on the audio according to the coding mode and the code rate in encoding of the audio and a low-frequency restoration model.

7. The audio processing method according to claim 1, wherein classifying the audio according to the contents of the audio includes:
classifying the audio according to a content of at least one of a history frame and a current frame in the audio.

8. The audio processing method according to claim 1, wherein updating the phase with the frequency higher than the cut-off frequency in the result of the amplitude superposition to the phase with the frequency lower than the cut-off frequency includes:
determining a phase corresponding to the result of the amplitude superposition according to the following expression:
$$∠Y = \{ \begin{matrix}∠X ( f ) , f < {f}_{c} \\ ∠X ( 2 {f}_{c} - f ) , f > {f}_{c}\end{matrix} ,$$
wherein <Y denotes the phase corresponding to the result of the amplitude superposition, <X(f) denotes a phase of the audio, and f_{c} denotes the cut-off frequency of the audio.

9. The audio processing method according to claim 1, wherein performing the amplitude superposition on the audio subjected to bandwidth extension and the audio subjected to low-frequency restoration according to the high-frequency restoration weight and the low-frequency restoration weight is implemented by the following expression:
$$\vert Y \vert = \vert X \vert + α {\vert X \vert}_{BWE} + β {\vert X \vert}_{LFR} ,$$
wherein |Y| denotes the result of the amplitude superposition, |X|_{BWE} denotes an amplitude of the audio subjected to bandwidth extension, |X|_{LFR} denotes an amplitude of the audio subjected to low-frequency restoration, α denotes the high-frequency restoration weight, β denotes the low-frequency restoration weight, |X| denotes an amplitude of the audio X, and α, β each have a value range of 0 to 1.

10. An electronic device, comprising:
at least one processor; and
a memory communicatively connected to the at least one processor,
wherein the memory stores instructions executable by the at least one processor, and the instructions are configured to cause, when executed by the at least one processor, the at least one processor to perform an audio processing method including:
classifying audio according to contents of the audio;
determining a high-frequency restoration weight and a low-frequency restoration weight based on a classification result;
performing amplitude superposition on the audio subjected to bandwidth extension and the audio subjected to low-frequency restoration according to the high-frequency restoration weight and the low-frequency restoration weight; and
updating a phase with a frequency higher than a cut-off frequency in a result of the amplitude superposition to a phase with a frequency lower than the cut-off frequency, to obtain a restored audio.

11. The electronic device according to claim 10, wherein in response to the audio being classified as mixed sound, determining the high-frequency restoration weight and the low-frequency restoration weight based on the classification result includes:
determining two sets of high-frequency restoration weights and low-frequency restoration weights;
wherein performing the amplitude superposition on the audio subjected to bandwidth extension and the audio subjected to low-frequency restoration according to the high-frequency restoration weight and the low-frequency restoration weight includes:
splitting the audio to obtain a foreground signal and a background signal; and
performing first sub-amplitude superposition on the foreground signal subjected to bandwidth extension and the foreground signal subjected to low-frequency restoration according to one set of the two sets of high-frequency restoration weights and low-frequency restoration weights, and performing second sub-amplitude superposition on the background signal subjected to bandwidth extension and the background signal subjected to low-frequency restoration according to the other set of the two sets of high-frequency restoration weights and low-frequency restoration weights.

12. The electronic device according to claim 11, wherein:
in the one set of the two sets of high-frequency restoration weight and low-frequency restoration weight, the high-frequency restoration weight takes a value approaching a left boundary of a value range of the high-frequency restoration weight, and the low-frequency restoration weight takes a value approaching a right boundary of a value range of the low-frequency restoration weight; and
in the other set of the two sets of high-frequency restoration weights and low-frequency restoration weights, the high-frequency restoration weight takes a value approaching a right boundary of a value range of the high-frequency restoration weight, and the low-frequency restoration weight takes a value approaching a left boundary of a value range of the low-frequency restoration weight.

13. The electronic device according to claim 11, wherein:
in the one set of the two sets of high-frequency restoration weights and low-frequency restoration weights, the high-frequency restoration weight takes a value approaching a left boundary of a value range of the high-frequency restoration weight, and the low-frequency restoration weight takes a value approaching a right boundary of a value range of the low-frequency restoration weight; or
in the other set of the two sets of high-frequency restoration weights and low-frequency restoration weights, the high-frequency restoration weight takes a value approaching a right boundary of a value range of the high-frequency restoration weight, and the low-frequency restoration weight takes a value approaching a left boundary of a value range of the low-frequency restoration weight.

14. The audio processing method according to claim 10, wherein:
in response to the audio being classified as music, the high-frequency restoration weight takes a value approaching a right boundary of a value range of the high-frequency restoration weight, and the low-frequency restoration weight takes a value approaching a left boundary of a value range of the low-frequency restoration weight;
in response to the audio being classified as human voice, the high-frequency restoration weight takes a value approaching a left boundary of a value range of the high-frequency restoration weight, and the low-frequency restoration weight takes a value approaching a right boundary of a value range of the low-frequency restoration weight; and
in response to the audio being classified as noise, the high-frequency restoration weight takes a value approaching a left boundary of a value range of the high-frequency restoration weight, and the low-frequency restoration weight takes a value approaching a left boundary of a value range of the low-frequency restoration weight.

15. The audio processing method according to claim 10, wherein before performing amplitude superposition on the audio subjected to bandwidth extension and the audio subjected to low-frequency restoration according to the high-frequency restoration weight and the low-frequency restoration weight, the audio processing method further comprises:
performing bandwidth extension on the audio according to a coding mode and a code rate in encoding of the audio and a bandwidth expansion model; and
performing low-frequency restoration on the audio according to the coding mode and the code rate in encoding of the audio and a low-frequency restoration model.

16. The audio processing method according to claim 10, wherein classifying the audio according to the contents of the audio includes:
classifying the audio according to a content of at least one of a history frame and a current frame in the audio.

17. The audio processing method according to claim 10, wherein updating the phase with the frequency higher than the cut-off frequency in the result of the amplitude superposition to the phase with the frequency lower than the cut-off frequency includes:
determining a phase corresponding to the result of the amplitude superposition according to the following expression:
$$∠Y = \{ \begin{matrix}∠X ( f ) , f < {f}_{c} \\ ∠X ( 2 {f}_{c} - f ) , f > {f}_{c}\end{matrix} ,$$
wherein <Y denotes the phase corresponding to the result of the amplitude superposition, <X(f) denotes a phase of the audio, and f_{c} denotes the cut-off frequency of the audio.

18. The audio processing method according to claim 10, wherein performing the amplitude superposition on the audio subjected to bandwidth extension and the audio subjected to low-frequency restoration according to the high-frequency restoration weight and the low-frequency restoration weight includes:
performing the amplitude superposition by the following expression:
$$\vert Y \vert = \vert X \vert + α {\vert X \vert}_{BWE} + β {\vert X \vert}_{LFR} ,$$
wherein |Y| denotes the result of the amplitude superposition, |X|_{BWE} denotes an amplitude of the audio subjected to bandwidth extension, |X|_{LFR} denotes an amplitude of the audio subjected to low-frequency restoration, α denotes the high-frequency restoration weight, β denotes the low-frequency restoration weight, |X| denotes an amplitude of the audio X, and α, β each have a value range of 0 to 1.

19. A non-transitory computer readable storage medium storing a computer program, wherein the computer program is configured to perform, when executed by a processor, an audio processing method including:
classifying audio according to contents of the audio;
determining a high-frequency restoration weight and a low-frequency restoration weight based on a classification result;
performing amplitude superposition on the audio subjected to bandwidth extension and the audio subjected to low-frequency restoration according to the high-frequency restoration weight and the low-frequency restoration weight; and
updating a phase with a frequency higher than a cut-off frequency in a result of the amplitude superposition to a phase with a frequency lower than the cut-off frequency, to obtain a restored audio.

20. The electronic device according to claim 10, wherein in response to the audio being classified as mixed sound, determining the high-frequency restoration weight and the low-frequency restoration weight based on the classification result includes:
determining two sets of high-frequency restoration weights and low-frequency restoration weights;
wherein performing the amplitude superposition on the audio subjected to bandwidth extension and the audio subjected to low-frequency restoration according to the high-frequency restoration weight and the low-frequency restoration weight includes:
splitting the audio to obtain a foreground signal and a background signal; and
performing first sub-amplitude superposition on the foreground signal subjected to bandwidth extension and the foreground signal subjected to low-frequency restoration according to one set of the two sets of high-frequency restoration weights and low-frequency restoration weights, and performing second sub-amplitude superposition on the background signal subjected to bandwidth extension and the background signal subjected to low-frequency restoration according to the other set of the two sets of high-frequency restoration weights and low-frequency restoration weights.
